(19) United States
(12) Patent Application Publication
(10) Pub. No.: US 2018/0247323 A1
(43) Pub. Date: Aug. 30, 2018

(54) Cross-Quota, Cross-Device, Universal Survey Engine

(71) Applicant: Research For Good, Seattle, WA (US)

(72) Inventors: Carl H. Sayres, Seattle, WA (US); David Sean Case, Limavady (GB); Matthew Ronco, Toronto (CA); Baillie Buchanan, Keller, TX (US); Michael Richard Kappel, Valencia (ES)

(21) Appl. No.: 15/968,489

(22) Filed: May 1, 2018

Related U.S. Application Data
(60) Provisional application No. 62/616,890, filed on Jan. 12, 2018.

(51) Int. Cl. G06Q 30/02

(52) U.S. Cl. CPC G06Q 30/0203

(57) ABSTRACT

A method that targets survey respondents more effectively for increased business profits uses answers provided by respondents to find a best match with particular surveys held in an inventory of surveys posted by researchers. Control of the respondent is maintained through to the completion of the surveys that are determined to be the best targets, and only then is an entire set of completed responses returned in a burst to the corresponding researcher. The result is an effective 100% incidence rate every time, near zero sample waste, and highly accurate and specific data is on-hand that is related to the costs and delays in fulfilling survey quotas.

### FIELD OF INVENTION

The present invention relates to opinion survey methods, and more particularly to those employing a universal survey engine that captures and retains qualified respondents, and then finds and matches each to an open survey in its inventory, and that keeps control of the respondents' experience to a survey completion.

### BACKGROUND

Identified and qualified respondents to surveys (known as ‘Sample’) are valuable business commodities. Identifying and qualifying respondents who fit various criteria and quotas has developed worldwide into a big business. Traditionally, respondents who have been identified by logging into a website and qualified by asking them a few questions have been handed off to a sponsoring Researcher with a Survey they authored that will ask more questions. This typically requires redirecting the respondent to another website. The sample provider that identified and qualified such respondents loses control of the respondent and drops out of the picture until the survey is completed.

As it happens, the conventional way of doing this is wasteful in a lot of ways. The Researcher with the Survey has only a narrow interest in the respondents referred to them, and has no practical means to avoid asking questions the respondent has already answered during targeting or on another survey.

Americans are universally familiar with opinion and market surveys, more now with the Internet and online shopping. And businesses everywhere have been using surveys to help management understand how well they are performing and how well a proposed product or service would do.

The traditional situation has been for someone with a survey to find respondents to answer their survey questions. Before launching into the survey, a respondent may be found to be unqualified. After launching into the survey, a respondent may disqualify themselves with their answers, and not be allowed by the survey to participate or proceed further.

Companies like Research for Good (Seattle, Wash.) have evolved to find, identify, provide, and redirect suitable respondents to market research survey websites. Such researchers will attach quotas to their surveys that describe artificial categories of respondents they seek, how many respondents in each category must be provided, and an incidence rate measure. The incidence rate measure is a measure of the suitability of the respondents sent into the survey. For example, 20% of those referred must be able to complete the survey.

There are often screening questions embedded in surveys that are not reflected in the Quotas. And so the market research company will send respondents into surveys that could have been saved the trouble if something had been known about the conditional path logic built into the survey and the questions the survey was posing. At present, when a respondent is referred and redirected into a researcher's survey, control of that respondent is lost.

Many surveys ask the same questions, albeit in different ways. Surveys independently designed by unrelated individuals using any authoring tool they choose will surely appear to be different, but nevertheless fundamentally be asking the same things. Almost every survey asks for the basic demographics of the individual respondents, and these can be very tedious and boring to answer, especially when asked repeatedly by multiple surveys.

Worthwhile surveys that produce actionable data generally depend on professionals to properly design and conduct the survey, and depend on respondents who were selected for their qualifications to provide meaningful responses. A business market has therefore developed in which researchers can hire services, professionals, equipment, and software to launch surveys and gather responses.

Some researchers attach respondent quotas to their surveys to ensure they get a representative sample which reflects the population they are targeting. And many researchers will shop around for estimates to conduct their surveys as defined by a list of questions to answer and the quotas to be filled. Researchers are, of course, looking to get the best results at the best costs. They want high quality survey responses and they want them at the lowest cost possible.

Respondents who are pre-screened can be left undisturbed if they are not qualified. But some respondents don't show themselves to be ineligible to fill a quota until they have already partially responded to the survey. Still other respondents will complete the survey only to have their participation and efforts wasted because the quota was filled without them.

The incidence rate in an opinion survey is the proportion of respondents who will complete the survey from the total number of those who are eligible. Any projections of the cost to conduct future surveys therefore involves uncertainties. Each new contact with a qualified respondent, and each new contact with a seemingly qualified respondent come with an incremental cost.

A proposed survey requested by a researcher will include a quota and the qualifications of the respondents that the researcher requires. Respondents engaged in such surveys are accumulated until the quota number of them has been fulfilled. The quota is then said to be closed. Screening or engaging respondents past the point of quota closure is therefore wasteful.

Surveys have become an important way for advertisers, manufacturers, political parties, and others to gauge how they are performing and what can be done better in the future. Every member of the public is familiar with surveys, both bad and good. The public can be fickle, and will turn off and leave a survey if they're annoyed with it or sense it's asking the wrong things. Respondents will tire easily when asked to try many surveys and especially when those surveys reject them as unqualified given the quota criteria.

Surveys are costly to conduct, and surveys that don't get to the truth about public opinion represent a wasted opportunity. So a variety of survey professionals and well-tuned survey companies, methods, and tools have developed over the years. Unfortunately, they don't share their proprietary results nor help each other target respondents better and avoid repetitious questions of the respondents or unqualified respondents. We want to analyze the actual surveys in order to directly extract the targeting and quotas, then every survey can be essentially turned into one with an effective 100% incidence rate (IR).

Being able to demonstrate and document the qualifications of a target base of respondents allows these professionals to bill at higher price points and deliver better, more useful results.

What is needed now are systems to precisely qualify respondents to respond to surveys, and to predict a respondent's likelihood of completing a survey. Open quotas for each survey need to be monitored in real time. An optimal use of the sample would result in a pseudo 100% Incidence Rate (IR), which is the percentage of persons who will complete the survey, given a targeted population.

### SUMMARY

Briefly, a method embodiment of the present invention that targets respondents more effectively for increased business profits uses samples (answers) provided by respondents to find a best match with particular surveys held in an inventory of surveys posted by researchers. Control of the respondent is maintained through to the completion of the surveys. Only after the survey is completed is an entire set of completed responses returned, in a burst, to the corresponding researcher. The result is an effective 100% incidence rate, near zero sample waste, and highly accurate and specific data is on-hand related to the costs and delays in fulfilling survey quotas.

Each step of the method is carried out by a universal survey engine embodiment of the present invention that collects a number of surveys from a variety of sponsoring researchers into a local survey inventory. The first job of the universal survey engine is to re-write each incoming survey into a common, universal survey format. This then enables the identification and elimination of redundant questions that bridge over all the surveys. The universal survey engine reads in the conditional logic and quotas from each survey description that act to selectively prevent some respondents from being able to complete the respective survey. The quotas limit the number of qualified respondents the corresponding researcher will accept. Respondents are then optimally targeted to the re-written surveys held locally in the survey inventory. The universal survey engine runs the survey with the respondents, and collects their answers. Answers to questions previously obtained from the particular respondents are fetched from a respondent answer inventory instead of being asked again. Answers to questions common to many surveys are penciled in to see which of these surveys would be most advantageous to steer into when a choice of one must be made. Control of the respondent is maintained by not passing the respondents off to researchers' or third party websites. A respondent could be detained to complete a few more questions that would complete more surveys in the local survey inventory.

### SUMMARY OF THE DRAWINGS

FIG. 1 is a flowchart diagram of a method embodiment of the present invention that matches and controls survey respondents to particular sponsored surveys in order to use the samples more effectively than do conventional methods;

FIG. 2 is a flowchart diagram of a method embodiment of the present invention like that of FIG. 1 and shows surveys collected into an inventory, and questions from those surveys being posed through user devices to respondents. The respondents answers are returned through the user devices and retained until a complete set of them can be returned to the original survey and researcher;

FIG. 3 is a flowchart diagram detailing how surveys re-written into our universal survey format are further separated into unifying and non-unifying questions;

FIG. 4 is a flowchart diagram detailing how pivotal questions in surveys are identified and matched to a set of lowest common denominator questions with the air of a human operator at a terminal;

FIG. 5 is a flowchart diagram detailing the flow optimization step in which respondents can resume from whence they left a previous interview;

FIG. 6 is a flowchart diagram detailing a Survey Rendering Framework; and

FIG. 7 is a functional block diagram of cross-quota, cross-device, Universal Survey Engine embodiment of the present invention that provides a platform for the execution and functioning of the methods illustrated in FIGS. 1-6.

### DETAILED DESCRIPTION OF THE EMBODIMENTS

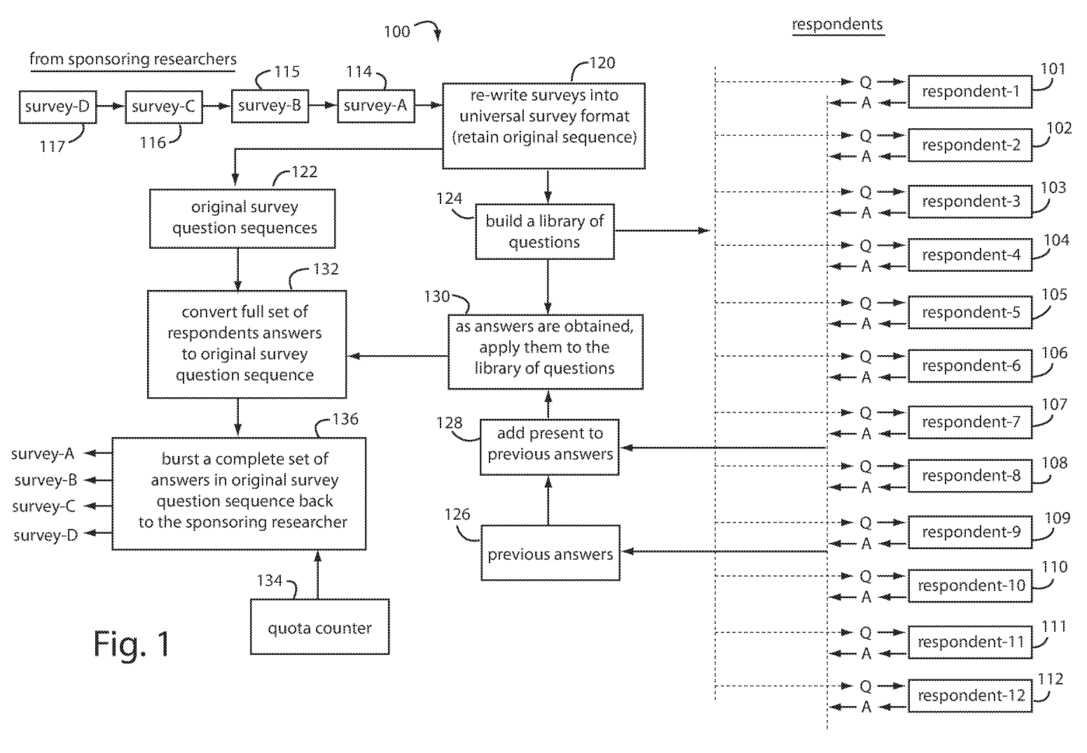

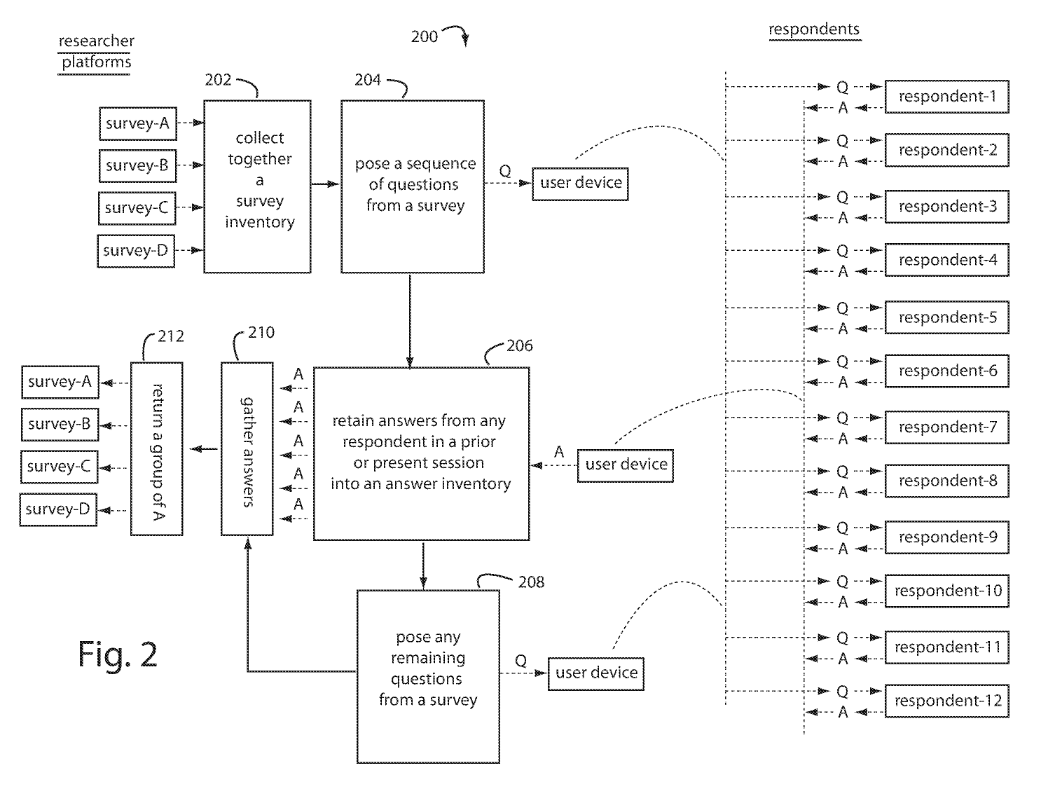

FIG. 1 provides a simple overview and top level understanding of a general embodiment of the present invention. Subsequent FIGS. 2-6 and their associated descriptions deal with the realities of real world applications and the variety of user devices that may be employed by survey respondents.

FIG. 1 represents a method embodiment 100 of the present invention that matches and controls survey respondents 101-112 to particular sponsored surveys 114-117 in order to use the samples more effectively than do conventional methods. One desirable result of which is increased business profits. A respondent 101-112 typically “arrives” on our doorstep sent by a source via an Internet link, and logs into a website of ours. (Other kinds of arrival are also common.)

In FIG. 1, survey respondents 101-112 and sponsored surveys 114-117 are a simple and clear way to represent the millions in each category that are both possible and easy-to-handle with modern webservers.

We maintain our “control” over each respondent by not sending them off alone to maybe complete any of surveys 114-117 on a sponsor's third party website or platform. Instead, we keep both the respondents' connections and the surveys they're matched-to local, and then we conduct the survey interviews ourselves from our website.

A step 120 re-writes each survey 114-117 into a universal survey format of ours because survey authoring tool formats and the styles of asking even the same question can vary significantly in the real world. We must retain the original sequence and format of surveys 114-117 in a step 122 to be able to later supply a complete proper response to the original survey 114-117 in its original format.

A step 124 then builds a library of questions to ask respondents 101-112 that represent all the questions in the surveys 114-117 and without any duplications. Since the questions asked by us are in our universal survey format, our respondents will be unaware if we switch them between surveys looking for which ones they are best suited to complete.

Respondents 101-112 are sent or referred to us by various sources, and they can arrive and depart from our website servers randomly, independently, individually, and unpredictably. We can engage many of them in parallel at the same time with surveys all derived from the library of questions.

A step 126 builds an inventory of previously obtained answers and prevents step 124 from asking the same questions again of the same respondents 101-112. Each respondent is identified as either a new respondent or someone we've seen before using an ID sent to us by a source, or using a stored cookie which allows us to see that this respondent is a returning visitor.

A step 128 adds presently obtained answers to any previously obtained answers in an effort to efficiently complete all the questions in a particular survey.

A step 130 applies all the answers obtained so far to all the questions in the library of questions. Some of the surveys we have in our universal survey format in our library of questions may be completed with the latest answers obtained.

If so, a step 132 converts a full set of respondents answers to the original survey question sequence, and prepares the set of answers obtained for transmission to the researchers' websites. We can therefore know in advance the incidence rate will be 100%. (All respondents that begin a survey will complete the survey, at least from the researchers' points of view.) We also know from a quota counter 134 that this respondent and these answers will not go to waste on a survey that had silently filled its quota. We know the respective quota is still open.

A step 136 bursts a complete set of answers in the original survey question sequence back to the corresponding sponsoring researcher. The quota counter 134 keeps track if this then fulfills the respective quota for survey 114-117. If so, the questions unique to it in the library of questions are removed from an active list.

Method 100 can therefore read and combine surveys from multiple external survey platforms into a universal survey format. Any “unifying questions” can be identified with artificial intelligence (AI) and human-assisted matching techniques. The datapoints generated are mapped to a “lowest common denominator”, allowing questions to be asked once, and applied to multiple surveys.

Bringing in the conditional logic and quotas associated with each survey, allows method 100 to determine the specific qualification criteria for each survey that should be applied to its respondents, and method 100 can then pre-determine if particular respondents will qualify.

The open quotas for each survey can be monitored in real time. This, along with the qualification criteria, produces a pseudo 100% incidence rate, and an optimal use of each sample.

Practical embodiments of method 100 should be able to display the combined surveys using multiple renderers targeted at multiple device types. Method 100 should also be enabled by its platforms and network servers to follow each respondent across their assorted devices. Respondents should be allowed to start a survey on one device and complete it on another.

Sometimes, however, respondents' preferences and/or survey requirements may not be compatible with every device type possible. For example, a critical graphic that cannot be displayed on an audio only connection like the Amazon Echo.

The key point is our control of the respondent is maintained on through to the completion of the surveys that we assessed to be the best targets. Only on 100% completion of the selected survey is an entire set of completed responses returned, in a burst, to the corresponding researcher. The result is an effective 100% incidence rate, near zero sample waste, and highly accurate and specific data is on-hand related to the costs and delays in fulfilling survey quotas.

Similarly, FIG. 2 represents a method 200 that improves the efficiencies in providing answers from respondents to complete surveys. A step 202 collects together into a survey inventory more than one survey sourced by a number of original survey platforms of sponsoring researchers. The questions, conditional logic, and quotas included each survey are comparable side-by-side to gauge which survey if selected would be better matched to any particular respondent. For example, according to a predetermined criteria. A step 204 poses a sequence of questions, if any, from the survey inventory to a respondent linked in through a user device. Each answer when returned by the respondent can satisfy questions common to more than one survey. A step 206 retains any answer from any respondent in a prior or present session into an answer inventory. Such is indexed by a number of identified respondents, and duplicative questions to any particular respondent are not posed. The answers to which are instead automatically supplied by the answer inventory. A step 208 poses any remaining sequence of unanswered questions unique to any one survey in the survey inventory to the respondent who has linked in through their user device.

One survey in the survey inventory is chosen according to the predetermined criteria. A step 210 completes the one survey, that was chosen from the survey inventory, by gathering together all the answers provided by a single respondent into a complete group of answers organized in an original sequence and format of that sourced by a corresponding sponsoring researcher. A step 212 returns to the corresponding sponsoring researcher the complete group of answers. Any quota associated with the one survey has been predetermined to still be open and unfulfilled at the time of returning, and the respondent providing the answers in the complete group of answers is predetermined to be qualified according to the quota and any conditional logic, and the incidence rate of respondents from the perspective of the corresponding sponsoring researcher is always 100%.

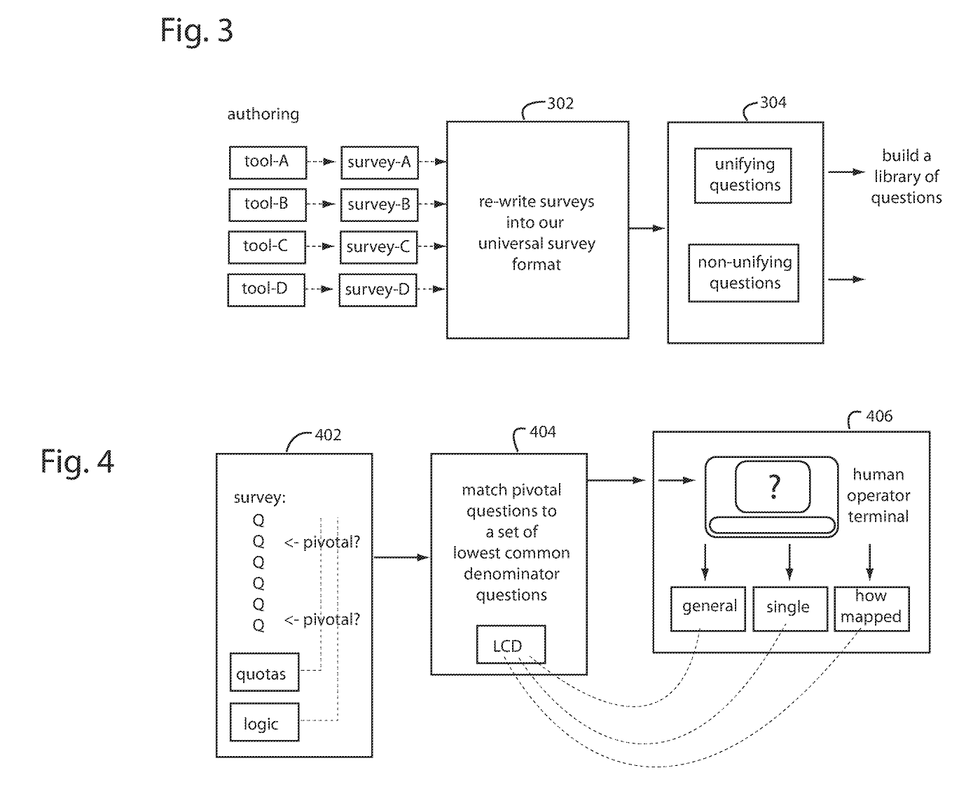

FIG. 3 represents how the step of collecting 202 further comprises a step 302 for re-writing each survey received from number of sponsoring researchers into a universal survey format before storing them each in the survey inventory. The differences that are typically caused by different authoring tools and differing styles in asking questions are removed. A step 304 separates the questions thus obtained in the universal survey format into “unifying questions” and “non-unifying questions”. Respondents are then targeted to surveys more efficiently by identifying common questions within surveys to build up a library of questions that can be asked once, and have the answers subsequently applied to many surveys.

FIG. 4 represents a further step 402 between the steps of collecting 202 and posing a sequence of questions 204. Step 402 locates which questions in any survey are pivotal questions according to their respective quotas and conditional logic, and which determine whether any particular respondent will be able to complete the survey. Such pivotal questions have conditional branches to prematurely take a respondent out of the survey. A step 404 matches any such pivotal questions to a set of lowest common denominator (LCD) questions according to word and phrasing similarities and ignoring whitespace, capitalization, and other trivial differences. A step 406 displays the pivotal questions to a human operator via a terminal if there is no match automatically obtained. The human operator is asked on screen to indicate how answers should be mapped to answers in the set of LCD questions. Or the human operator can be asked if the pivotal question is general purpose enough and should be added as unifying question to the set of LCD questions. Or the human operator can be asked if the pivotal question is not general purpose enough and should be left as a single-use screener question, that is, a non-unifying question.

Alternative to involving a human operator and asking them questions, an artificial intelligence robot may be substituted. In such case the pivotal question would be forwarded to the artificial intelligence robot if there is no match automatically obtained. Such might be provided by a specialized service in the Cloud. The artificial intelligence robot is asked to map the answers in the set of LCD questions. It may be asked too if the pivotal question is general purpose enough and should be added as unifying question to the set of LCD questions. If the pivotal question is not general purpose enough, such should be left as a single-use screener question (a non-unifying question).

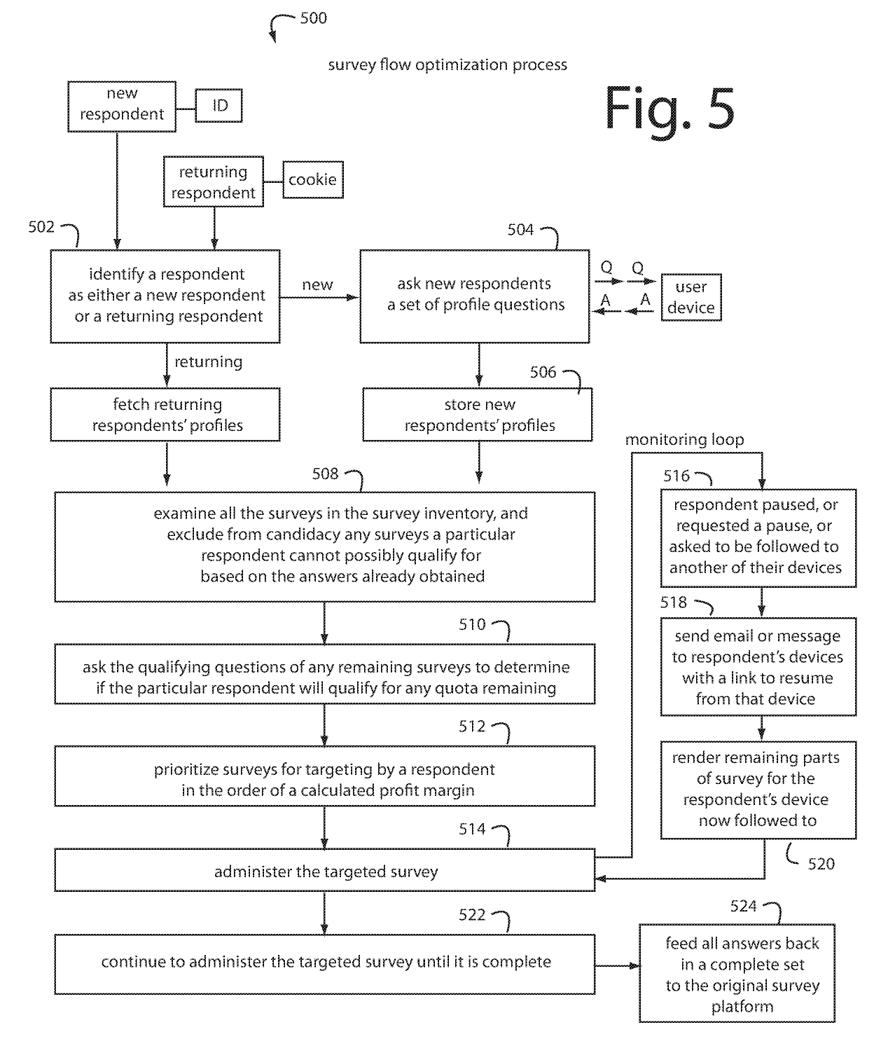

FIG. 5 represents a survey flow optimization process 500 that includes a step 502 for identifying a respondent as either a new respondent or a returning respondent. E.g., using an identification included by a source, or by using a stored cookie. A step 504 asks all new respondents a predefined set of profile questions appropriately rendered through their collection of user devices. A step 506 then stores their answers to these questions in the answer inventory. A goal of this is to allow the questioning in a current interview of any returning respondent to resume from a place where it was left off in a prior interview. A step 508 examines all the open surveys still outstanding in the survey inventory, and excludes from candidacy any surveys that a particular respondent cannot possibly qualify for (based on their answers already obtained). Exclusions are based further on any still open quotas for such surveys. A step 510 asks the qualifying questions of any remaining surveys in an effort to determine if the particular respondent will qualify for any quota remaining. A step 512 prioritizes for targeting a respondent to the surveys in the order of a calculated profit margin if more than one survey has a quota that remains open to the particular respondent. A step 514 administers the targeted survey by asking a sequence of questions from it once it has been selected, and using a survey rendering framework to do the asking through a selected user device.

The survey flow optimization process 500 uses a step 516 to monitor whether the respondent has paused, requested a pause, or asked to be followed to another of their devices. If so, a step 518 sends an email or an SMS message to each of the respondent's collection of devices with a link to resume step 514 from that device Otherwise, step 514 advances unfazed. But if the respondent is being followed to another device, a step 520 renders the remaining parts of the survey in step 514 for the respondent's particular device now being followed to.

A step 522 loops back through steps 514, 516, 518, and 520 until the survey has been completed by the respondent. A step 524 feeds all answers obtained from the respondent back in a complete set to the original survey platform. Until then the survey platform has not been made aware this respondent even started to answer any of the survey's questions.

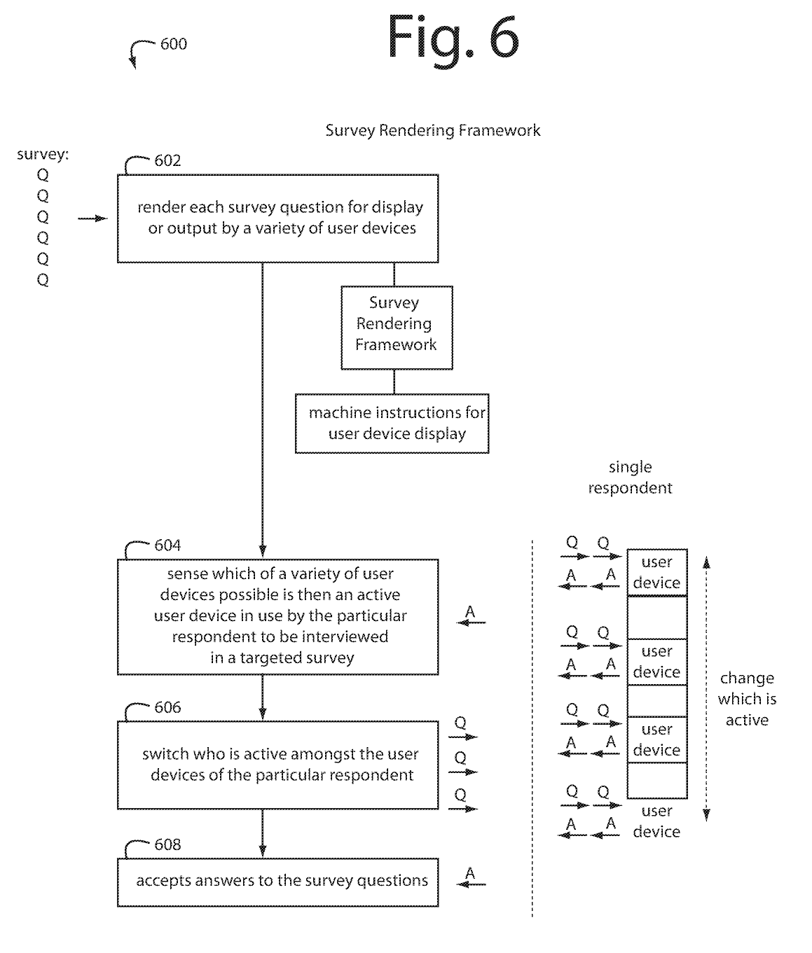

FIG. 6 represents a Survey Rendering Framework step 600 that includes a step 602 for rendering each survey question for display or output by a variety of user devices with a Survey Rendering Framework. A step 604 senses which of a variety of user devices possible is then an active user device in use by the particular respondent to be interviewed in a targeted survey. A step 606 switches amongst the user devices of the particular respondent by sending a corresponding rendering of a survey question for display or output by a then active user device. A step 608 accepts answers to the survey question, as entered from the then active user device, and into the answer inventory. The survey rendering framework includes machine instructions for displaying each type of question in the universal survey format for each type of user device. The same survey can be presented on any user device, and the respondent can seamlessly switch amongst user devices even in the middle of a survey interview.

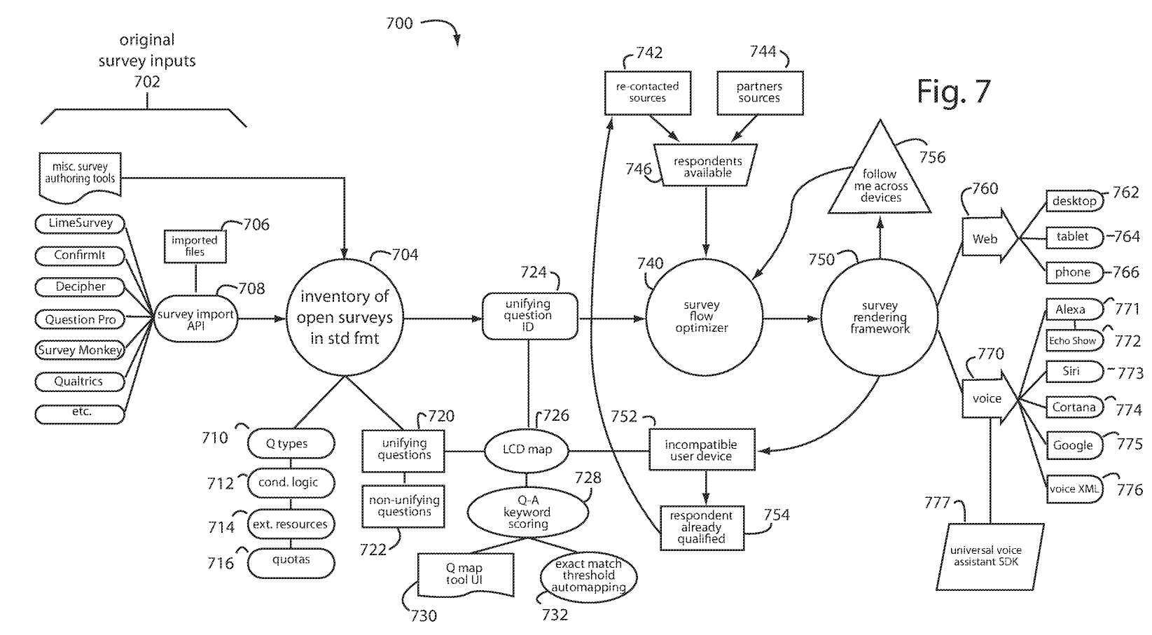

FIG. 7 illustrates a universal survey engine embodiment of the present invention, and is referred to herein by numeral 700. The left side of the diagram provides an input 702 for new open surveys in their original formats. (For example, surveys 114-117 in FIG. 1.) These are sent by independent and unrelated sponsoring researchers from their respective platforms. All such surveys are accumulated in an inventory 704 of open surveys in a standardized format. (Such as done in step 120 of FIG. 1)

The new open surveys at input 702 are brought in by directly reading an authoring tool's file formats, querying an external database, or using the tool's applications programming interface (API). Of course other methods of input are possible.

The individual questions, type, logic, and quotas of every open survey will each arrive in its own free-form and format that is inconsistent with the others, e.g., Qₐ, Q_{b}, Q_{c}, Q_{d}, . . . , and such must be converted and harmonized into a standardized common format, e.g., Q_{A}, Q_{B}, Q_{C}, Q_{D}, . . . , before its being placed in survey inventory 704.

Every question (Qₐ, Q_{b}, Q_{c}, Q_{d}, . . . ) can be asked in many different ways in a variety of natural languages. So it is the job of survey inventory 704 to discern what fundamentally is being asked, and then compose a common format question (Q_{A}, Q_{B}, Q_{C}, Q_{D}, . . . ) for storage in survey inventory 704 that would solicit the same answer. A selection of these common format questions for a complete open survey can then be posed later to respondents as they arrive and are pre-qualified for particular open surveys. Keeping in mind each respondent must answer every question in the open survey, or none at all.

The associations between which open surveys asked which survey questions (maintained in standardized common format) must not be lost. Respondents ultimately qualifying and chosen to give answers will have their answers forwarded in their correct slots to the respective surveys and used to fill their corresponding survey quotas.

A Question-A (QA), for example, may be asked by all or most of the open surveys. And so QA is a “unifying question”. Each open survey will be inventoried within universal survey engine 700. The surveys are randomly downloaded and input by a variety of means. For example, a survey import applications programming interface (API) 708 is connected to receive open surveys built from several dissimilar commercial survey authoring platforms and tools.

Since these researchers are independent and unrelated, they are each free to author their surveys any way they want. That often means the employment of LimeSurvey, ConfirmIt, SPSS, Decipher, QuestionPro, Survey Monkey, Qualtrics, and the like will be used. These, and other, web server-based web interfaces provide users a way to develop and publish on-line surveys, collect responses, create statistics, and export the resulting data in files through corresponding API's to other applications.

Before being placed into an inventory 704, each incoming open survey must be parsed into the questions it poses. A single standardized question is then found to fit each of its questions. Open surveys can then be inventoried by their constituent standardized questions. Respondents will only be posed the standardized questions later in a consistent and uniform way.

Each survey source typically adheres to its own proprietary format, but that variability can frustrate automated systems trying to aggregate information from each imported survey data file. (These are referred to herein generally as files 706.) The harmonization needed is especially challenging when trying to do the aggregation using high speed machines alone. So, a universal survey formatter using artificial intelligence (AI) techniques is employed to harmonize and aggregate the survey responses imported from different sources into a single, proprietary Universal Survey Format.

This represents a first step in creating the AI tools that can read the contents of others' surveys and translate them all into our universal survey format. Depending on the source, a universal survey import API 708 reads the respective file formats, queries a database, or uses the corresponding tool's API. From that it obtains question types 710, conditional logic 712, external resources 714, and quotas 716.

Most surveys today are built using a common set of question types 710, e.g., Single select, Multiple select, Ratings (choose a number from 1 to N), Grids (multiple ratings), Text Entry (respondent can type any text), etc.

Each survey authoring platform has its own unique features, but most questions they can pose can be generalized into one of a few common types. This allows survey questions from multiple authoring tools, or imported in files 706, to be employed simultaneously, and then to treat each on a level playing field after our harmonization. Any embedded conditional logic 712 and quotas 716 are extracted from the survey's description. Here, conditional logic 712 is any path code that was embedded into each survey that is used to modify its linear question-asking behavior path according to the responses being received.

For example, if a respondent has indicated that they are unemployed, the survey might then skip any follow-up questions about employment, such as one that asks for a job title. This detail would be moot for someone unemployed, and a source of annoyance if asked. We parse the condition codes 712 and convert them for use in our Universal Survey Format 708.

Quotas 716 describe the number and qualifications of each of the set of respondents that a particular survey requires, e.g., as established by a researcher sponsoring the Survey. For example, a survey might be targeting both Men and Women, with a Household Income (HHI) of $40 k-$80 k, and who drive a Toyota car. So the survey quotas might be:

| | |
|---|---|
| Men | HHI $40k-$60k drive a Camry: 24 |
| Men | HHI $61k-$80k drive a Camry: 24 |
| Women | HHI $40k-$60k drive a Camry: 26 |
| Women | HHI $61k-$80k drive a Camry: 26 |
| Men | HHI $40k-$60k drive a Prius: 24 |
| Men | HHI $61k-$80k drive a Prius: 24 |
| Women | HHI $40k-$60k drive a Prius: 26 |
| Women | HHI $61k-$80k drive a Prius: 26 |

In each quota 716, a new survey being constructed will fix a minimum number of qualified people the survey requires to have completely responded. Here, embodiments of the present invention recognize that many responses from qualifying people may already be on hand. If so, no need to ask again.

Once a quota 716 is fulfilled, the collection of samples is closed. Any newly arriving respondents meeting the description will not be eligible. The number of people fixed in each quota 716 is determined by a Researcher designing the survey and is a balance of competing considerations.

In one instance, Researchers may assume that a population of female car buyers may be slightly larger than for men. For each authoring tool, a proprietary code of ours would be used to read the quotas of imported survey data files and convert them to our universal survey format.

Establishing quotas is essential. The ultimate goal is to be able to fill each quota as efficiently as possible, therefore always with zero wasted samples.

In a unifying question identification 720 our goal is to be able to target respondents to surveys more efficiently than what is possible with conventional techniques. To do this, we identify questions that were or would be common amongst our surveys with a unifying question identification 724. This is used to build a library of questions that can be asked once, and then those answers can be used as a basis for instant and zero cost responses in subsequent surveys.

Once a survey has been imported and read, quotas 716 and conditional logic 712 are used to find if any pivotal questions exist which can be used to determine if a respondent will be allowed to complete the survey. FIG. 4 illustrates these steps.

The questions are matched first against a set of Lowest Common Denominator (LCD) questions, e.g., in an LCD map 726. These LCD questions allow a re-use of the answers that have already been provided by a respondent. A matching algorithm ignores trivial differences (e.g., whitespace, capitalization) and scores how similar any question is to a question already in the LCD set. E.g., using a Q-A keyword scorer 728.

We are interested in very close matches only. If a match is not found, then the question will be displayed to a human operator who we depend on to decide if the question matches an existing question in the LCD set. See step 406 in FIG. 4.

If yes, the operator maps the answers to the answers in the LCD set using a Question-mapping tool UI 730. If not, the operator decides if the question is general purpose enough to become a new LCD question (Unifying Questions) and adds it to a Library. Or the operator can leave it as a single-use screener question, a Non-unifying Question 722.

It's essential to create questions with as many unique, orthogonal answers as is possible when adding new LCD questions 722. Such allows many versions of the question to be mapped, without conflicts for an auto-mapper 732. It is possible to add answer options later, e.g., a new car make or model, new tech device which may be owned, new type of education certification, etc.

A survey flow optimizer (SFO) 740 identifies respondents as being either a new respondent not already qualified, or someone that's been seen here before. FIG. 5 illustrates method 500 that can be used here. Any re-contacts 742 or respondents from partners 744 are accepted as respondents 746. A respondent ID is sent by the source. Or a cookie can be used that was previously stored by a webpage to recognize if a particular respondents is returning.

All new respondents are asked a typical and universal set of predefined qualifying profile questions, e.g., age, gender, postal code, employment status, marital status, income, etc. As in step 504 in FIG. 5. Returning respondents will be rerouted to pick up where they left off in any prior interview. The profile answers can be used later on.

For each new respondent, and all those already enrolled, all the surveys in the inventory are examined for any surveys a respondent cannot possibly qualify for, and they are excluded. As in step 510 of FIG. 5. Of course this is based on the answers already on hand, and the open quotas attached to the surveys.

For each remaining survey that may be already on hand, the SFO 740 asks qualifying questions of the respondent to determine if the respondent qualifies for any open quotas 716. If more than one survey exists with unfulfilled quotas, the surveys are prioritized in their order of a potential business profit.

Once a survey is selected for response, SFO 740 asks its particular survey questions using a Survey Rendering Framework 750. The SFO 740 continues delivering the survey to active respondents until the quotas are fulfilled. Once a survey with a particular respondent is complete, their answers are fed back to survey platform 704. As in step 516 of FIG. 5.

SFO 740 enables each respondent to pause and switch their digital devices in mid-survey. As also seen in FIG. 6, Survey Rendering Framework 750 adapts the same survey questions for a correct presentation on each device type. E.g., a respondent might start taking a survey via voice on a mobile phone while driving home. Then they can continue the survey an hour later on their laptop at home.

Some surveys may ask a respondent to input a type of response that is not compatible with the device types then in their hands. That can require a device change, such as when a video needs to be displayed that is not possible on a voice-only device.

Survey Rendering Framework 750 provides each machine the embedded instructions the device needs to display each type of question in our Universal Survey Format. The same survey can thus be presented on any device, and that is what allows respondents to pause and switch devices mid-survey.

If, for example, the original survey asked: “Please rate the level of customer service you received:” it then expects answers from 1 to 10, where 1 is poor service and 10 is great service. For a voice interface, the question might be asked aloud as follows: “Please rate the level of customer service you received. You can say any number from 1 to 10, where 1 means poor service, and 10 means great service.” The renderer 771-776 then waits for the respondent to say a number 1:10.

Survey Rendering Framework 750 uses a tiered hierarchy to allow a variety of customized renderers 762-776 to be switched in for each general type of device. For example, there could be a generic HTML renderer 760 for a question, or a more specific renderer 766 for phones, or an even more specific renderer for iPhones, or an even more specific renderer than that for an iPhone 5s. Similarly, we include a generic voice renderer 770, or renderers that are specifically targeted to Alexa 771, Cortana 774, or Voice XML 776.

A Universal Voice Software Development Kit (SDK) API 777 provides a single programming API for users who want to build voice applications targeting multiple voice controlled devices, e.g., Alexa 771, Cortana 774, Siri 773, Google Assistant 775, Voice XML 776, etc. The Universal Voice SDK creates a software abstraction layer, which provides software developers a single API to target and be able to deploy their applications to any voice platform.

The Universal Voice SDK is configured as an efficient to build any voice portion of Survey Rendering Framework 750.

The SDK 777 is standalone, and licensable separate product for developers to build voice applications.

When all the Surveys can be aggregated into a common system, and where the survey logic of each can be known, a perfect pre-screening can be realized. It will be possible to know for sure that a given Respondent can complete the survey, and that the corresponding Quotas are still open. Embodiments of the present invention rapidly pre-screen for many surveys, and optionally administer the entire survey right within the local system. Respondents never leave the system, and each can complete a survey more efficiently than with any conventional system.

Although particular embodiments of the present invention have been described and illustrated, such is not intended to limit the invention. Modifications and changes will no doubt become apparent to those skilled in the art, and it is intended that the invention only be limited by the scope of the appended claims.

1. A method that improves the efficiencies in providing answers from respondents to complete surveys, comprising:
collecting together into a survey inventory more than one survey sourced by a number of original survey platforms of sponsoring researchers such that the questions, conditional logic, and quotas included each survey are comparable side-by-side to gauge which survey can be better matched to any particular respondent according to a predetermined criteria;
posing a sequence of questions, if any, from the survey inventory to a respondent linked in through a particular user device in a collection of user's devices, wherein each answer when returned by the respondent satisfies a question common to more than one survey;
retaining any answer from any respondent in a prior or present session into an answer inventory, which is indexed by a number of identified respondents, and such that duplicative questions to any particular respondent are not posed and the answers to which are instead automatically supplied by the answer inventory;
posing any remaining sequence of unanswered questions unique to any one survey in the survey inventory to the respondent linked in through their user device, wherein which one survey in the survey inventory is chosen according to the predetermined criteria;
following the respondent across devices, allowing the respondent to complete a survey in multiple sessions where each session may be communicated through a different device or device type such as a web browser, a mobile phone or a voice activated device,
completing the one survey, that was chosen from the survey inventory, by gathering together all the answers provided by a single respondent into a complete group of answers organized in an original sequence and format of that sourced by a corresponding sponsoring researcher; and
returning to the corresponding sponsoring researcher the complete group of answers;
wherein, any quota associated with the one survey has been predetermined to still be open and unfulfilled at the time of returning, and the respondent providing the answers in the complete group of answers is predetermined to be qualified according to the quota and any conditional logic, such that the incidence rate of respondents from the perspective of the corresponding sponsoring researcher approaches 100%.

2. The method of claim 1, wherein the step of collecting further comprises:
re-writing each survey received from a number of sponsoring researchers into a universal survey format before storing them each in the survey inventory, and such that the differences cause by different authoring tools and differing styles in asking questions is removed; and
separating the questions thus obtained in the universal survey format into unifying questions and non-unifying questions;
wherein, respondents are targeted to surveys more efficiently by identifying unifying questions within surveys to build up a library of questions that can be asked once, and the answers applied to many surveys.

3. The method of claim 1, further comprising between the steps of collecting and posing a sequence of questions:
locating which questions in any survey are pivotal questions according to their respective quotas and conditional logic, and which determine whether any particular respondent will be able to complete the survey, wherein such pivotal questions have conditional branches to prematurely take a respondent out of the survey;
matching any such pivotal questions to a set of lowest common denominator (LCD) questions according to word and phrasing similarities and ignoring whitespace, capitalization, and other trivial differences; and
displaying the pivotal question to a human operator via a terminal if there is no match automatically obtained, and asking the human operator to indicate how answers should be mapped to answers in the set of LCD questions, or asking if the pivotal question is general purpose enough and should be added as unifying question to the set of LCD questions, or asking if the pivotal question is not general purpose enough and should be left as a single-use screener question, that is, a non-unifying question.

4. The method of claim 1, further comprising a survey flow optimization process that includes:
identifying a respondent as either a new respondent or a returning respondent using an identification included by a source, or by using a stored cookie;
asking all new respondents a predefined set of profile questions through their user devices, and then storing their answers to them in the answer inventory, wherein a questioning in a current interview of any returning respondent resumes from a place where it was left off in a prior interview;
examining all the surveys in the survey inventory, and excluding from candidacy any surveys a particular respondent cannot possibly qualify for based on the answers already obtained, and based further on any still open quotas for such surveys;
asking the qualifying questions of any remaining surveys to determine if the particular respondent will qualify for any quota remaining;
prioritizing for targeting a respondent to the surveys in the order of a calculated profit margin if more than one survey has a quota that remains open to the particular respondent;
administering the targeted survey by asking a sequence of questions from it once it has been selected, and using a survey rendering framework to do the asking through a user device; and
continuing to administer the targeted survey until it is complete, and only then feeding the all answers in a group back to the original survey platform.

5. The method of claim 1, further comprising:
rendering with a Survey Rendering Framework each survey question for display or output by a variety of user devices;
sensing which of the variety of user devices is then an active user device in use by the particular respondent to be interviewed in a targeted survey;
switching amongst the user devices of the particular respondent by sending a corresponding rendering of a survey question for display or output by a then active user device; and
accepting answers to the survey question, entered from the then active user device, into the answer inventory;
wherein, the survey rendering framework includes machine instructions for displaying each type of question in the universal survey format for each type of user device, and wherein the same survey can be presented on any user device, and the respondent can seamlessly switch amongst user devices even in the middle of a survey interview.

6. The method of claim 4, further comprising in the survey flow optimization process:
monitoring whether the respondent has paused, requested a pause, or asked to be followed to another of their devices;
if so, sending an email or an SMS message to each of the respondent's collection of devices with a link to resume the survey from that device, and rendering any remaining parts of the survey for the respondent's particular device now being followed to;
looping back through steps until the survey has been completed by the respondent; and
feeding all answers obtained from the respondent back in a complete set to the original survey platform, wherein, until then the survey platform has not been notified that this respondent even started to answer any of the survey's questions

7. A cross-quota, cross-device, universal survey engine, comprising:
a survey import applications programming interface (API) to receive survey questions, answers, and programming logic content from a number of dissimilar survey authoring tools employing a variety of data formats in the files they export;
a universal survey formatter that converts imported surveys employing a variety of authoring tool formats into a single universal survey format;
a unifying question identifier that separates questions obtained in the universal survey format into unifying questions and non-unifying questions;
a survey flow optimizer with access to the unifying questions and non-unifying questions;
a survey rendering framework connected to interface the survey flow optimizer to user devices of respondents;
wherein, the universal survey engine is useful to collect, build, conduct, and economize surveys for increased profits; and
wherein, the universal survey format enables a harmonization of data imported from a variety of survey authoring tools; and
wherein, new surveys are managed and rendered to the many user devices a user may employ with seamless switching between them.

8. The universal survey engine of claim 7, wherein the survey flow optimizer functions to:
identify a respondent as either a new respondent or a returning respondent using an identification included by a source, or by using a stored cookie;
ask all new respondents a predefined set of profile questions through their user devices, and then storing their answers to them in the answer inventory, wherein a questioning in a current interview of any returning respondent resumes from a place where it was left off in a prior interview;
examine all the surveys in the survey inventory, and excluding from candidacy any surveys a particular respondent cannot possibly qualify for based on the answers already obtained, and based further on any still open quotas for such surveys;
ask the qualifying questions of any remaining surveys to determine if the particular respondent will qualify for any quota remaining;
prioritize for targeting a respondent to the surveys in the order of a calculated profit margin if more than one survey has a quota that remains open to the particular respondent;
administer the targeted survey by asking a sequence of questions from it once it has been selected, and using a survey rendering framework to do the asking through a user device; and
continue to administer the targeted survey until it is complete, and only then feeding the all answers in a group back to the original survey platform.

9. The universal survey engine of claim 7, wherein the unifying question identifier functions to:
locate which questions in any survey are pivotal questions according to their respective quotas and conditional logic, and which determine whether any particular respondent will be able to complete the survey, wherein such pivotal questions have conditional branches to prematurely take a respondent out of the survey;
match any such pivotal questions to a set of lowest common denominator (LCD) questions according to word and phrasing similarities and ignoring whitespace, capitalization, and other trivial differences; and
display the pivotal question to a human operator via a terminal if there is no match automatically obtained, and asking the human operator to indicate how answers should be mapped to answers in the set of LCD questions, or asking if the pivotal question is general purpose enough and should be added as unifying question to the set of LCD questions, or asking if the pivotal question is not general purpose enough and should be left as a single-use screener question, that is, a non-unifying question.

10. The universal survey engine of claim 7, wherein the survey flow optimizer functions to:
monitor whether the respondent has paused, requested a pause, or asked to be followed to another of their devices;
if so, send an email or an SMS message to each of the respondent's collection of devices with a link to resume step 514 from that device;
otherwise it advances unfazed;
if the respondent is to be followed to another device, then render any remaining parts of the survey for the respondent's particular device then being followed to;
loop back and repeat until the survey has been completed by the respondent;
feed all answers obtained from the respondent back in a complete set to the original survey platform;
wherein, until then the survey platform has not been informed that this respondent even started to answer any of the survey's questions.
